(19) United States
(12) Patent Application Publication
(10) Pub. No.: US 2026/0366515 A1
(43) Pub. Date: Nov. 19, 2026

(54) ELECTRICAL FEEDTHROUGH, VACUUM APPARATUS AND METHOD FOR ASSEMBLY

(71) Applicant: Edwards Limited, Burgess Hill, Sussex (GB)

(72) Inventor: James Alexander Haylock, Burgess Hill, Sussex (GB)

(21) Appl. No.: 18/843,071

(22) PCT Filed: Mar. 1, 2023
(86) PCT No.: PCT/GB2023/050456

§ 371 Date: Aug. 30, 2024

(30) Foreign Application Priority Data
Mar. 1, 2022 (GB) 2202801.3

(51) Int. Cl. F04D 25/06; F04D 29/08; F04D 29/64

(52) U.S. Cl. CPC F04D 25/0693; F04D 29/083; F04D 29/644

(57) ABSTRACT

Electrical feedthrough, in particular for a vacuum pump, comprising a wall element having two or more openings preferably connectable to or being part of a vacuum pump/vacuum apparatus, wherein contact elements extend through each of the openings having a first end and an opposite second end, wherein individual seal elements are disposed between each of the contact element and the wall element such that the openings are vacuum sealed.

### CROSS-REFERENCE OF RELATED APPLICATION

This application is a Section 371 National Stage Application of International Application No. PCT/GB 2023/050456, filed Mar. 1, 2023, and published as WO 2023/166283 A1 on Sep. 7, 2023, the content of which is hereby incorporated by reference in its entirety and which claims priority of British Application No. 2202801.3, filed Mar. 1, 2022.

### FIELD

The present invention relates to an electrical feedthrough in particular for vacuum apparatus or vacuum pump, a vacuum apparatus and in particular a vacuum pump having such an electrical feedthrough and a method for assembly of such an electrical feedthrough.

### BACKGROUND

Vacuum pumps and vacuum systems often need to operate with some electrical components or sub systems within the vacuum environment. These typically require an electrical connection through the wall of the vacuum chamber to systems outside the vacuum environment which provide electrical power and control. The electrical connections are typically made via an electrical connector which is sealed against vacuum. These are variously referred to as vacuum feedthrough connectors or vacuum lead-throughs or hermetically sealed electrical connectors. Vacuum feedthrough connectors typically have one or more electrical connection pins arranged in a metal or plastic connector body that conflates the number of connection pins. The best vacuum seals are often formed by a glass-to-metal seal between the connection pins and the connector body which also provides electrical isolation between the connection pins and the connector body. The connector body will typically be sealed to the vacuum system using an O-ring which allows easy assembly and disassembly of the feedthrough to the vacuum system. Therein, the O-ring is arranged between the connector body and the wall of the vacuum system. Connections to the vacuum side of the electrical feedthrough are typically made with flying leads. Connections to the other side of the electrical feedthrough may be flying leads soldered directly to the connection pins; or may use an electrical connector which mates with the vacuum feedthrough to provide an easy means of disconnection.

In some systems the electrical connector will be attached to a cable, and in other systems the electrical connector may be directly mounted to a printed circuit board (PCB) or control module. In the latter case great care must be taken to ensure alignment of the electrical connector with the feedthrough in the mounting arrangement of the PCB or control module so as to avoid side forces on the electrical connections due to misalignment. Side forces or misalignment may lead to compromised electrical connections or insufficient sealing of the electrical feedthrough.

Thus, it is an objective of the present invention to provide an electrical feedthrough which is easy to assemble and more reliable.

The discussion above is merely provided for general background in-formation and is not intended to be used as an aid in determining the scope of the claimed subject matter. The claimed subject matter is not limited to implementations that solve any or all disadvantages noted in the background.

### SUMMARY

The technical problem is solved by an electrical feedthrough according to claim 1, a vacuum apparatus according to claim 12 and a method for assembly of such an electrical feedthrough according to claim 13.

The electrical feedthrough according to the present invention, in particular for a vacuum apparatus or a vacuum pump, comprises a wall element which is connectable to the vacuum pump or vacuum apparatus. Alternatively, the wall element is integrally built with or being part of the vacuum pump or vacuum apparatus. The wall element has two or more openings or apertures wherein contact elements extend through each of the openings having a first end on one side of the wall element and an opposite second end on the other side of the wall element. The first end may extend into a vacuum chamber of a vacuum apparatus or vacuum pump while the second end is disposed outside the vacuum chamber, i.e. outside the vacuum environment. Alternatively, the second end may extend into a vacuum chamber of a vacuum apparatus or vacuum pump while the first end is disposed outside the vacuum chamber. Thereby the contact elements provide electrical contact to the interior of the vacuum chamber. According to the present invention an individual seal element is disposed between each of the contact elements and the wall element in order to seal the respective opening of the wall element in a vacuum tight manner. Thus, the number of seal elements corresponds to the number of the contact elements, i.e. for each contact element an individual seal element is foreseen. Preferably, there is direct contact between the seal element and the respective contact elements and/or direct contact between the seal element and the wall element. No intermediate parts are necessary such as any connector body as used in the prior art, simplifying the structure of the feedthrough and thereby also simplifying the assembly procedure. Since the wall element has individual openings for the respective contact elements and not a single opening to receive the connector body as in prior art, slight misalignment between the contact elements and the openings is acceptable without the loss of the vacuum seal. Upon misalignment, by the present invention each of the contact elements are slightly misaligned individually without any effects to the vacuum seal. In the prior art the complete connector body of the feedthrough must be tilted upon misalignment, thereby deteriorating the seal efficiency which might result in a vacuum leak. Thus, by the present invention, a reliable electrical feedthrough is provided.

Preferably, exactly one contact element is extending through one of the openings. Thus, the number of contact elements and the number of openings in the wall element are equal.

Preferably, the seal element is an O-ring. Then, the opening of the wall element may be circular to conform the shape of the O-ring. Alternatively, the opening may have an oval, or square or any other special cross section, wherein the seal element conforms with the shape to provide a vacuum tight seal.

Preferably, the respective seal element surrounds the contact element and is in particular in direct contact with the respective contact element without any intermediate parts or elements. Thereby, the number of necessary parts for the electrical feedthrough can be reduced and commercially available contact elements can directly be used off the shelf without preassembly to a connector body or the like.

Preferably, the respective seal element is in direct contact with the wall element without any intermediate parts or elements. Thereby, the number of necessary parts for the electrical feedthrough can be reduced and commercially available seal elements can directly be used off the shelf without preassembly or the like.

Preferably, the contact elements are contact pins. In particular, the diameter of the contact pins are between 0.5 mm and 10 mm, wherein larger diameter allow to deliver higher currents into the vacuum chamber. In particular, the contact pins have a constant diameter from the first end and to the second end. Alternatively, the diameter at the first end may be smaller than the diameter at the second end or vice versa. Thus, along the contact pin in between a stepped or an inclined/tapered section arises, wherein preferably this stepped or inclined section is at the same axial position as the sealing element interacting with the sealing element in order to improve the sealing effect due to an increased clamping effect between the contact element and the sealing element.

Alternatively, the contact pin has a first diameter at the first end, a second diameter at the second end and a third diameter at the position of the seal element, wherein the fist diameter might be equal or different to the second diameter and wherein the third diameter is larger than the first diameter and/or the second diameter. Thus, flexibility in contact design can be provided while at the same time sufficient sealing is maintained. Also, for different contact designs the contact elements need not to be adapted when keeping the third diameter constant.

Preferably, the sealing element is electrically insulating preventing electrical connection between the respective contact elements and the wall element.

Preferably, the first end of one contact element, preferably more than one contact element and more preferably all contact elements are connected to a printed circuit board (PCB), a wire as flying lead or may be connected to a plug, socket, electrical connector or the like. Alternatively or additionally, the second end of one contact element, preferably more than one contact element and more preferably all contact elements are connected to a PCB, a wire or a plug, socket, electrical connector or the like.

Preferably, the PCB is connected to the contact elements via connecting elements providing electrical contact between the PCB and the contact elements. Therein, by the connecting elements the PCB can be connected to the first end of the contact elements, thus being arranged in the vacuum chamber of a vacuum apparatus or vacuum pump, or the connecting elements can be used to connect a PCB disposed outside the vacuum chamber to the second end of the contact elements.

Preferably, the connecting elements are cup shaped or provide an axial abutment for the contact elements. In particular, if the contact elements are to be connected to a PCB disposed inside the vacuum chamber, the contact elements may be connected to the PCB via inserting the contact elements into the connecting elements. By the cup shape or the axial abutment of the connecting elements, the contact elements cannot be inserted too far into the vacuum chamber and define an axial position of the contact elements. Thus, the assembly is simplified, and a reliable and reproducible axial position of the contact elements is guaranteed. However, cup shaped connecting elements could also be used at the second end outside the vacuum to further limit axial movement also at the second end.

Preferably, the connecting elements are sleeves surrounding the respective contact elements. In particular, for connecting the contact elements to a PCB arranged outside the vacuum chamber, the connecting elements are built as sleeves. The PCB can be attached to the contact elements by inserting the contact elements into the respective connecting elements or, alternatively, by putting the connecting elements over the inserted contact elements. However, sleeve shaped connecting elements could also be used at the first end inside the vacuum.

Preferably, one opening, more than one opening or all openings comprise a restricted portion. Therein, the seal element is received in the recess defined by the restricted portion. By the restricted portion pushing through of the seal element is avoided when inserting the seal element.

Preferably, two or more openings are built differently. Alternatively, all openings of the wall element are built identically.

Preferably, the openings or recesses have a conical cross section or a taper towards the wall element facilitating insertion of the seal element into the respective recesses or openings of the wall element.

Preferably, an assembly aid is provided releasably connected to the electrical feedthrough. Therein, the assembly aid comprises openings corresponding to the openings of the wall element. In particular, the openings of the assembly aid match with the position of the openings of the wall element. Thus, there is the same number of openings in the assembly aid as in the wall element. In particular, the position of the assembly aid is fixed relative to the wall element and has for example a fixed rotational position relative to the wall element. Therefore, the assembly aid or the wall element may comprise orienting features such as detents or keyways interacting/engaging a corresponding orienting feature of the respective other part. Thus, by the orienting feature the rotational position of the assembly aid relative to the wall element is fixed. By the assembly aid inserting of the contact elements as well as the sealing elements is simplified. Therein, preferably the openings of the assembly aid have a conical cross section or a taper towards the wall element facilitating insertion of the seal element into the respective recesses or openings of the wall element.

In another aspect, the present invention relates to a vacuum apparatus and in particular a vacuum pump comprising a housing defining a vacuum chamber. Therein, an electrical feedthrough as described above is connected to the housing or integrally built with the housing such that a first end of the contact elements is disposed within the vacuum chamber and an opposite second end of the contact element is outside the vacuum chamber.

In another aspect, the present invention relates to a method for assembly of an electrical feedthrough, wherein the electrical feedthrough is in particular built as previously described. The method includes the steps of:

Providing at least two openings in a wall element of vacuum apparatus, in particular a vacuum pump;

Inserting contact elements through each of the openings; and Inserting individual seal elements between each of the contact elements and the wall element.

Thus, in a first step a wall element is provided having at least two openings or apertures. In a second step contact elements are inserted into the openings extending through the openings such that a first end of the contact elements may extend into a vacuum chamber of the vacuum apparatus or vacuum pump, wherein an opposite second end may be arranged outside the vacuum chamber. Preferably, exactly one contact element is inserted into one opening such that the number of contact elements is equal to the number of openings. In a third step individual seal elements are inserted between each of the contact elements and the wall elements, i.e. into the openings of the wall element. Therein, for each contact element exactly one seal element is inserted, wherein the seal element is preferably in direct contact with the respective contact element and may surround the contact element. By the seal elements the openings of the wall element are sealed in a vacuum tight manner. However, the order of steps of the method can be adapted accordingly. Thus, it is also encompassed the situation that first the seal element is inserted and afterwards the contact elements are inserted into the openings.

Preferably, before inserting the contact elements into the respective openings of the wall element, a PCB is connected to the wall element at a vacuum side, i.e. the PCB is arranged within the vacuum chamber. Then, by inserting the contact elements through the openings of the wall element, the contact elements are at the same time connected to the PCB within the vacuum chamber. Alternatively, the contact elements are inserted and subsequently the PCB is connected at the vacuum side.

Preferably, before inserting the contact elements and/or seal elements an assembly aid is releasably connected to the wall element, wherein the assembly aid has openings corresponding to the openings of the wall element, i.e. their position and size, in order to guide insertion of the contact element and/or the seal element. Thus, by the assembly aid assembly of the contact element and/or the seal element is facilitated thereby simplifying the assembly of the electrical feedthrough.

Preferably, the method is further developed according to the features described above with respect to the electrical feedthrough.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

In the following the present invention is described with reference to the accompanying figures.

The figures show:

FIG. 1 an electrical feedthrough according to the present invention,

FIG. 2 the electrical feedthrough according to FIG. 1 in a misaligned configuration,

FIG. 3 an electrical feedthrough according to the present invention including an assembly aid during assembly and

FIG. 4 a flow diagram of the method for assembly the electrical feedthrough according to the present invention.

### DETAILED DESCRIPTION

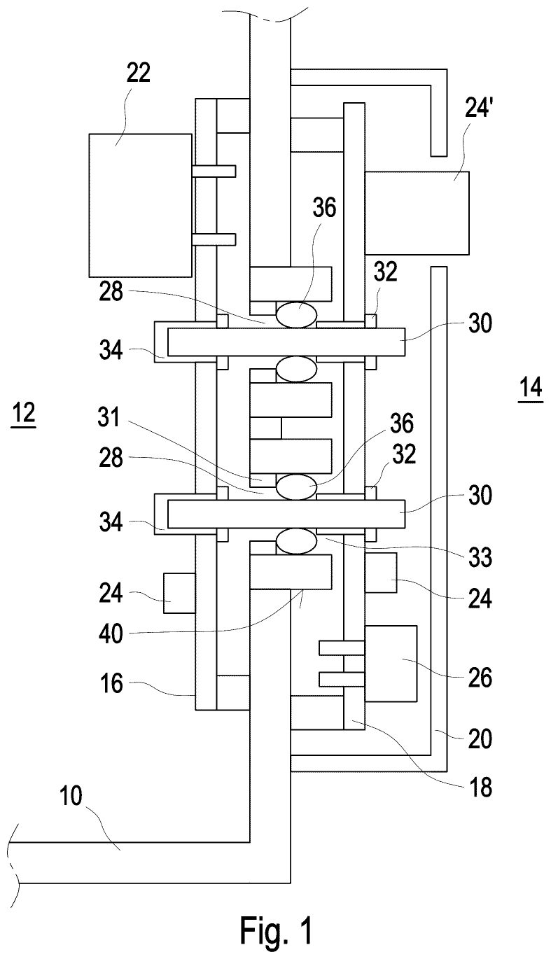

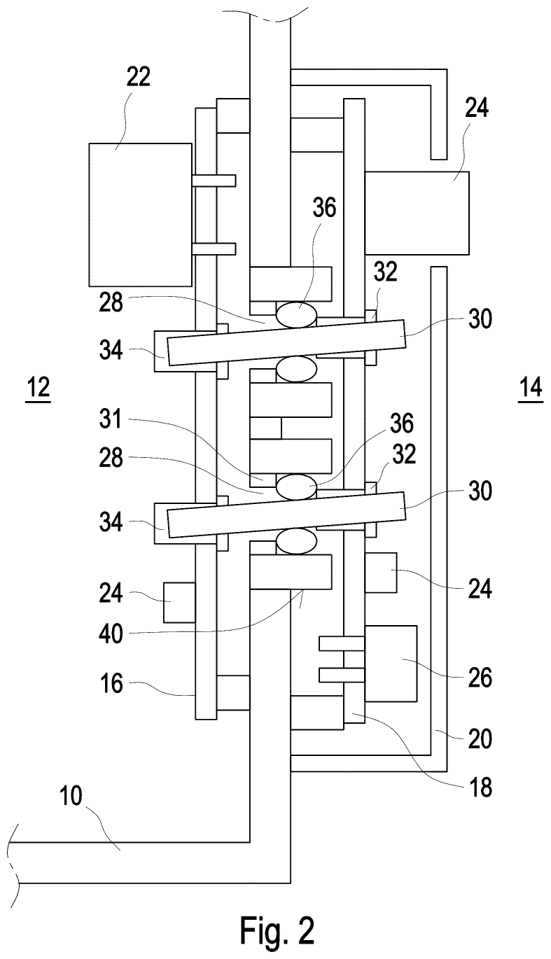

Referring to FIG. 1 showing an electrical feedthrough according to the present invention. Therein, the electrical feedthrough comprises a wall element 10 being connected to or integrally built with a housing of a vacuum apparatus, in particular a vacuum pump. By the housing of the vacuum apparatus a vacuum chamber 12 is defined with a vacuum or low pressure and an opposite outside 14 having an ambient pressure for example. The wall element 10 has in the example shown in FIG. 2 two openings or apertures 28. However, the present invention is not limited to the exact number of openings such that three or more openings are also within the scope of the present invention. Through each of the openings 28 a contact element 30 is extending such that a first end of the contact element 30 extends into the vacuum chamber 12, wherein an opposite second end extends into the outside 14. Therein, the contact elements 30 are depicted as contact pins having a constant cross-section. Alternatively, the cross-section of the contact pins may vary such that the contact pin has a larger diameter at the first end than the second end or vice versa.

For each contact element 30 exactly one opening 28 is provided in the wall element 10 or, the other way around, in each of the openings 28 exactly one contact element 30 is inserted. Further, a seal element 36 is disposed around each of the contact elements 30, wherein the seal element 36 may be built as O-ring. The seal element 36 surrounds the contact element 30 and is in direct contact with the contact element 30. Further, the seal element 36 is in direct contact with the wall element 10 in order to provide a gas tight seal to maintain the vacuum in the vacuum chamber 12. In particular, by the openings 28 a recess 33 is formed having a restricted portion 31 to limit axial movement of the seal element 36 when inserted from the outside 14 into the recess 33. Therein, no additional parts are necessary except the contact element 30 and the seal element 36. In particular, the contact element 30 is not contacted to any connector body to conflate more than one contact element. Thereby, the number of parts of the electrical feedthrough can be reduced.

In particular, the seal elements 36 are arranged in the recesses 33 built by the wall element 10. Therein, the recess 33 may have a diameter between 2 mm and 15 mm and preferably a diameter between 3 mm and 8 mm. Further, the contact elements 30 are made of an electrical conducting material such as copper, brass or silver and may have a length between 5 mm and 100 mm and more preferably between 8 mm and 20 mm and may have a diameter between 0.5 mm and 10 mm and more preferably between 1 mm and 5 mm. Therein, if the contact element 30 has a different diameter at the first end than at the second end, an inclined/tapered section or a stepped section may be arranged within the recess 33 and being in direct contact with the seal element 36 in order to increase the sealing effect of the seal element 36. Further, increased diameter of the contact element 30 may provide the possibility to transfer higher currents. In addition, the seal element 36 may be built from an electrical insulating material in order to isolate the electric contact of the contact element 30 from the wall element 10.

Hence, by the contact elements 30 an electric connection between the outside 14 and the vacuum chamber 12 is provided.

In the example of FIG. 1, a first printed circuit board (PCB) 16 is connected to the vacuum side of the wall element, i.e. inside the vacuum chamber 12. The first PCB 16 may carry an electrical motor 22 or an electrical sensor 24. However, the present invention not limited to any specific electronic components carried by the first PCB 16. Therein, the contact elements 30 are connected to the first PCB 16 by first connecting elements 34. The first connecting elements 34 may be cup shaped and provide an axial limitation to the insertion movement of the contact elements 30 from the outside 14 through the openings 28 into the vacuum chamber 12. This insertion movement of the contact elements 30 stops upon abutment of the first end of the contact elements 30 with the bottom of the cup shaped first connecting elements 34. In particular, the inner diameter of the first connecting elements 34 corresponds to outer diameter of the contact elements 30. Alternatively, the inner diameter of the first connecting elements 34 may be larger than the outer diameter of the contact elements 30 and a spring-loaded pressing element may provide the contact between the contact elements 30 and the first connecting elements 34.

In the example of FIG. 1 a second PCB 18 is disposed at the outside 14 and connected to the wall element 10. The second PCB 18 carries further electronic components such as motor controller 24′, sensor controller 26 or other sensors 24. However, the present invention is not limited to the specific electronic components connected to the second PCB 18 and any other electronic components can be connected to the second PCB 18. Therein, the contact elements 30 are connected to the second PCB 18 by second connecting elements 32. The second connecting elements 32 are built as sleeves surrounding the respective contact elements 30. Therein, the inner diameter of the sleeves may correspond to the outer diameter of the contact elements 30 to provide an electronic contact. Alternatively, the inner diameter of the second connecting element 32 may be larger than the outer diameter of the contact element 30. Then the second connecting element 32 may comprise a spring-loaded pressing element providing electrical contact between the contact element 30 and the second connecting element 32.

In addition, a cover 20 may cover the electrical feedthrough for further protection.

Referring to FIG. 2 showing the same electrical feedthrough as described with reference to FIG. 1. However, there is a misalignment between the first PCB and the second PCB 18. As shown in FIG. 2, this slight misalignment can be compensated by the electrical feedthrough according to the present invention. Since individual contact elements 30 are used to provide an electrical connection between the vacuum chamber 12 and the outside 14, upon misalignment of the first PCB 16 and/or the second PCB 18, each contact element 30 is slightly tilted to compensate this misalignment. Therein, tilt of the contact elements 30 by up to 15° or less, preferably 10° or less and most preferably 6° or less are acceptable without having any influence on the sealing of the respective openings 28. If, as in the prior art, the contact elements 30 would be conflated into one contact element by a connector body, no compensation would be possible without loss of the vacuum inside the vacuum chamber 12.

In addition, as clearly seen in FIGS. 1 and 2, the present electronic feedthrough has a reduced number of parts. In fact, only the contact element 30 and the seal element 36 are necessary to provide an electronic contact through the wall element 10.

Although it is shown in FIG. 1 that the first end and the second end of the contact elements 30 are connected to respective first PCB 16 and second PCB 18, other connections are also possible. Thus, the first end of the contact element 30 and/or the second end of the contact element 30 may be connected to a plug or may be connected to a wire as flying lead.

Although it is described that the contact elements 30 have a round or substantially round cross-section, other shapes are also possible. The same applies to the recess 33 formed by the wall element 10 as well as the respective openings 28.

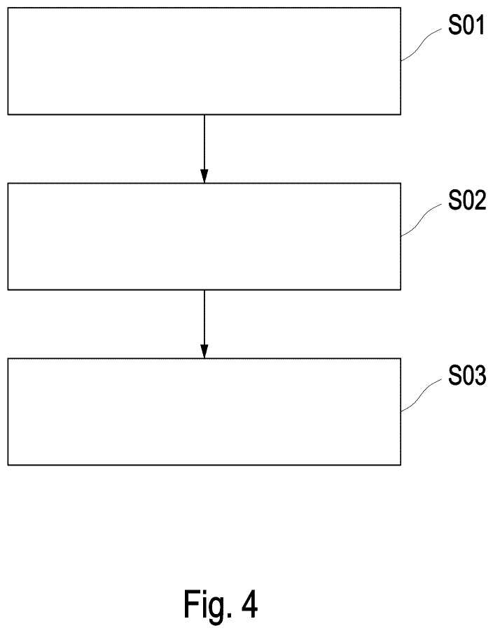

Referring to FIG. 4 showing a flow diagram for assembly of the electrical feedthrough according to the present invention. In step S01 a wall element is provided having two or more openings. Therein, the wall element 10 may be connected to or integrally built with a housing of a vacuum apparatus or vacuum pump. Therein, by the housing a vacuum chamber is defined containing a low pressure or vacuum. In step S02 contact elements 30 are inserted into each of the openings 28. Therein, preferably, exactly one contact element 30 is inserted into each opening 28 of the wall element 10.

In step S03 sealing elements 36 are inserted into the openings 28 or respective recesses 33 built by the openings to provide a gas tight seal of the openings 28. Therein, the seal elements 36 may be in direct contact with both, the contact element 30 and the wall element 10. Therein, for each contact element 30 an individual seal element 36 is inserted such that the number of seal elements 36 is equal to the number of contact elements 30 and more preferably equal to the number of openings 28.

Thus, by the contact elements 30 a reliable electrical feedthrough is provided which is easy to assemble due to the reduced number of necessary parts and provides a reliable sealing even under misalignment of the contact elements 30.

Preferably, before inserting the contact elements 30 in step S02 a first PCB 16 is connected to the vacuum side of the wall element 10. Therein, preferably, first connecting elements 34 are already in place and connected to the first PCB 16. Subsequently, in step S02, contact elements 30 are inserted through the respective openings 28 of the wall element 10 into the cup shaped first connecting elements 34 in order to provide an electrical contact between the contact elements 30 and the first PCB 16.

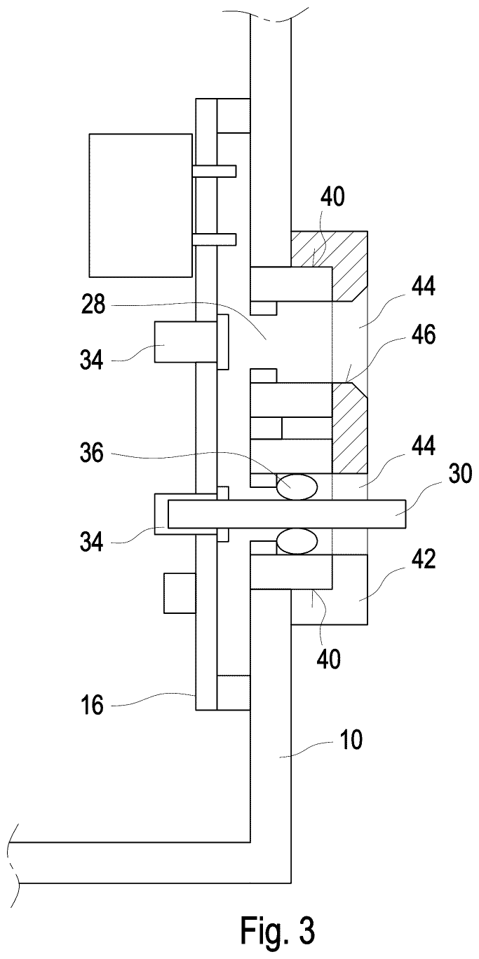

Preferably, before inserting the contact elements 30 in step S02 and more preferably after connecting the first PCB 16 at the vacuum side of the wall element 10, an assembly aid 42 is releasably connected to the wall element 10. Therein, the assembly aid 42 is releasably connected to the wall element 10 in order to aid assembly of the contact elements 30 and/or the seal elements 36. Upon insertion of the contact elements 30 and/or seal elements 36, the assembly aid is removed. Therein, the assembly aid 42 has openings 44 corresponding with the openings of the wall element. As exemplified in the FIG. 3 the inner surfaces 46 of the openings 44 of the assembly aid 42 are aligned with the inner surfaces of the respective openings 28 or recesses 33. Further, by the wall element 10 an alignment surface 40 may be provided in order to align the assembly aid 42 with respect to the openings 28 of the wall element 10. Further, orienting features may be implemented in order to provide a fixed relative position between the assembly aid 42 and the wall element 10. For example, the orienting features may be provided by detents and keyways preventing rotation of the assembly aid around the position at the wall element 10 and fixing a relative rotational position between the wall element 10 and the assembly aid 42. Further, in order to facilitate insertion of the seal elements 36, the openings 44 of the assembly aid 42 may have a tapered diameter with a decreasing diameter towards the wall element 10. Thus, insertion of the seal elements 36 is simplified due to the increased diameter at the end of the openings 44 towards the outside 14. Then the seal elements 36 can be press fit into the recesses 33 of the respective openings 28 to provide a vacuum tight seal. In FIG. 3 the situation is exemplified that one contact element 30 and one seal 36 are inserted already. In a next step the second contact element 30 is inserted and subsequently the second seal element 36 is inserted in the other opening 28.

Preferably, after inserting the seal element a second PCB may be connected to the wall element 10 at the outside 14 of the housing. Preferably, the contact elements 30 extending through openings in the second PCB 18. Therein, second connecting elements 32 may be already in place providing electrical contact between the contact elements 30 and the second PCB 18 upon insertion of the contact elements 30 into the openings of the second PCB 18 when connecting the second PCB 18 to the wall element 10. Alternatively, first the second PCB 18 is put in place and connected to the wall element 10, thereby the contact elements 30 extending through apertures of the second PCB 18. Subsequently, second connecting elements 32 are inserted into these apertures of the second PCB 18 providing electrical contact between the contact elements 30 and the second PCB 18.

However, even though the method of assembly is described above with a certain order of the steps, other embodiments of the present invention might deviate from this order where necessary. The order of steps for assembly can be freely selected and is not limited by the above given example or the figures.

Thus, by the present invention a simplified and reliable electrical feedthrough is provided which provides electrical contact and vacuum tight seal even under slight misalignments.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. An electrical feedthrough, in particular for a vacuum pump, comprising:
a wall element having two or more openings preferably connectable to or being part of a vacuum pump/vacuum apparatus,
wherein contact elements extend through each of the openings having a first end and an opposite second end,
wherein individual seal elements are disposed between each of the contact element and the wall element such that the openings are vacuum sealed.

2. The electrical feedthrough according to claim 1, characterized in that exactly one contact element extending through each of the openings.

3. The electrical feedthrough according to claim 1, characterized in that the seal elements are O-rings.

4. The electrical feedthrough according to claim 1, characterized in that the respective seal element surrounds the contact element.

5. The electrical feedthrough according to claim 1, characterized in that the contact elements are contact pins.

6. The electrical feedthrough according to claim 1, characterized in that the first end of each of the contact elements is connected to a printed circuit board, PCB, plug, socket, electrical connector or a wire.

7. The electrical feedthrough according to claim 1, characterized in that the second end of each of the contact elements is connected to a PCB, a wire or plug.

8. The electrical feedthrough according to claim 6, characterized in that the PCB is connected to the contact elements via connecting elements providing an electrical contact between the PCB and the contact element.

9. The electrical feedthrough according to claim 8, characterized in that the connecting elements are cup shaped or provide an axial abutment for the contact elements.

10. The electrical feedthrough according to claim 8, wherein the connecting elements are a sleeve surrounding the respective contact elements.

11. The electrical feedthrough according to claim 1, characterized by an assembly aid releasably connected to the electrical feedthrough, wherein the assembly aid comprises openings corresponding to the openings of the wall element.

12. A vacuum apparatus, in particular a vacuum pump, comprising a housing defining a vacuum chamber, wherein an electrical feedthrough according to claim 1 is connected to the housing or integrally built with the housing such that a first end of the contact elements is disposed within the vacuum chamber and a second, opposite end outside the vacuum chamber.

13. A method for assembly of an electrical feedthrough, according to claim 1, with the steps:
providing at least two openings in a wall element of vacuum apparatus, in particular a vacuum pump;
inserting contact elements through each of the openings; and
inserting individual seal elements between each of the contact elements and the wall element.

14. The method according to claim 13, including connecting a PCB to the wall element at a vacuum side.

15. The method according to claim 13, wherein an assembly aid is connected to the wall element, wherein the assembly aid has openings corresponding the openings of the wall element to guide insertion of the contact element and the seal element.
